(19) United States
(12) Patent Application Publication
(10) Pub. No.: US 2009/0057218 A1
(43) Pub. Date: Mar. 5, 2009

(54) PROTECTOR AND FLUID FILTER USING SAME

(75) Inventors: Tsutomu HANASE, Aichi-ken (JP); Masahiro TOMITA, Aichi-ken (JP)

Correspondence Address: GREENBLUM & BERNSTEIN, P.L.C., 1950 ROLAND CLARKE PLACE, RESTON, VA, 20191, US

(73) Assignee: TOYOTA BOSHOKU KABUSHIKI KAISHA, Aichi-ken (JP)

(21) Appl. No.: 12/177,261

(22) Filed: Jul. 22, 2008

(30) Foreign Application Priority Data
Aug. 28, 2007 (JP) 2007-221482
Aug. 28, 2007 (JP) 2007-221483

(51) Int. Cl. B01D 25/176

(52) U.S. Cl. 210/230

(57) ABSTRACT

The present invention provides a protector and a fluid filter using the protector in which the protector, which supports a cylindrical filter element so as to prevent the filter element from being crashed, can be assembled easily by a manual operation, the number of components of the protector can be reduced, and the protector can be assembled easily even with differing length. A fluid filter comprising a protector for supporting a filter element, the protector includes a support having a cylindrical portion and a first joint portion, a pedestal having a pedestal main body and a second joint portion joined to the first joint portion, a valve body provided in a valve body housing portion, and a spring that biases the valve body to a through hole side, wherein the first joint portion and the second joint portion are connected to each other by a snap fit structure.

### BACKGROUND OF THE INVENTION

1. Field of the Invention

The present invention relates to a protector and a fluid filter using the protector, and more particularly to a protector and a fluid filter using the protector in which the protector, which supports a cylindrical filter element from a center side so as to prevent the filter element from being crushed, can be assembled easily by a manual operation, the number of components of the protector can be reduced, thereby enabling a reduction in cost, and the protector can be assembled easily even with differing lengths. The present invention also relates to a protector and a fluid filter using the protector with which positional deviation occurring during assembly can be eliminated.

2. Description of the Related Art

A fluid filter formed by housing a filter element in a casing constituted by a cap and a base is known in the related art. A fluid filter is provided with a cylindrical protector that supports the cylindrical filter element from a center side and prevents crushing of the filter element when pressure is applied from the outside.

As shown in FIG. 10, a protector 100 includes a cylindrical support 102 having a plurality of penetrating holes 101, a pedestal 103, a valve body 104 provided between the support 102 and the pedestal 103, a plate spring 105 for biasing the valve body 104 toward the pedestal 103 side, and a rivet (not shown) for connecting the support 102 to the pedestal 103 (see Patent Document 1). The support 102 and the pedestal 103 are both made of steel plate, and are fixed to each other by caulking. The valve body 104 and the plate spring 105 function as a relief valve for relieving the oil pressure from the exterior of the filter element 106 to the interior thereof when a filter element 106 becomes clogged, for example.

However, in this conventional protector 100, both the support 102 and the pedestal 103 are made of steel plate, and therefore caulking and a rivet are preferably used to join the two, leading to an increase in the number of components. Moreover, specialized tools are required to retain the caulking and the rivet, and therefore assembly becomes difficult in locations where sufficient tools are not available or the operational precision decreases, for example overseas.

Meanwhile, the length of the filter element 106 is selected from various lengths in accordance with the subject filter element, and therefore, in order to assemble a protector 100 for holding a filter element 106 of a certain standard (length), a support 102 having a suitable length must be used. In this case, however, a specialized rivet retention tool that is appropriate for the length must be used, and therefore it is not easy to assemble protectors 100 having different lengths.

Patent Document 1: Japanese Patent Application Publication No. JP-A-2007-54715

### SUMMARY OF THE INVENTION

[Problems to be Solved by the Invention]

The present invention has been designed in consideration of the circumstances described above, and it is an object thereof to provide a protector and a fluid filter using the protector in which the protector can be assembled easily by a manual operation, the number of components of the protector can be reduced, thereby enabling a reduction in cost, and the protector can be assembled easily even with differing lengths. Another object of the present invention is to provide a protector and a fluid filter using the protector in which the protector, which supports a cylindrical filter element from a center side so as to prevent the filter element from being crushed, can be assembled easily by a manual operation, and with which positional deviation occurring during assembly can be eliminated.

[Means for Solving Problem]

The present invention is as described below.
1. A fluid filter, comprising:

a filter element;

a protector for supporting said filter element; and

a cap and a base that house said filter element and said protector and can be screwed to each other by relative rotation,

wherein said protector comprises:

a support having a cylindrical portion and a first joint portion provided on one end side of said cylindrical portion, a plurality of penetrating holes being provided in a peripheral surface of said cylindrical portion;

a pedestal having a pedestal main body and a second joint portion provided on said pedestal main body and joined to said first joint portion, a through hole being provided in a partition wall for separating said pedestal main body from said second joint portion;

a valve body provided in a valve body housing portion that is formed by joining said first joint portion to said second joint portion; and

a spring that is provided in said valve body housing portion and biases said valve body to said through hole side,

said support and said pedestal are made of resin, and

said first joint portion and said second joint portion are connected to each other by a snap fit structure.
2. The fluid filter according to 1 above, wherein said cylindrical portion further comprises a transverse rib that traverses the interior thereof in a diametrical direction.
3. The fluid filter according to 2 above, wherein said first joint portion comprises a pawl portion, and said second joint portion comprises an engaging portion that engages with said pawl portion.
4. The fluid filter according to 1 above, wherein one of said first joint portion and said second joint portion comprises a pawl portion, and the other has a cylindrical shape and comprises an engaging portion that is engaged with said pawl portion by a snap fit structure,

a tip end surface of said pawl portion is inclined in a circumferential direction of said engaging portion,

said engaging portion comprises one or more engaging ribs provided in an axial direction on an inner peripheral surface thereof, and

an end surface of said engaging rib opposing said tip end surface of said pawl portion is inclined in an identical direction to said tip end surface.
5. The fluid filter according to 4 above, wherein an angular portion on an inner peripheral side end surface of said engaging portion is chamfered.
6. The fluid filter according to 5 above, wherein said pawl portion is provided at an incline such that a root side thereof approaches a central axis of said engaging portion.
7. The fluid filter according to 2 above, wherein said cylindrical portion and/or said second joint portion comprises an orbital rib provided in a circumferential direction, and an outer peripheral surface angular portion of said orbital rib on said pedestal main body side is chamfered.
8. The fluid filter according to 3 above, wherein said cylindrical portion and/or said second joint portion comprises an orbital rib provided in a circumferential direction, and an outer peripheral surface angular portion of said orbital rib on said pedestal main body side is chamfered.
9. The fluid filter according to 6 above, wherein said cylindrical portion and/or said second joint portion comprises an orbital rib provided in a circumferential direction, and an outer peripheral surface angular portion of said orbital rib on said pedestal main body side is chamfered.
10. The fluid filter according to 7 above, wherein a filter element stopper projection is formed on said cylindrical portion and/or said second joint portion in a site thereof that is contacted by an inner peripheral surface of said filter element.
11. The fluid filter according to 8 above, wherein a filter element stopper projection is formed on said cylindrical portion and/or said second joint portion in a site thereof that is contacted by an inner peripheral surface of said filter element.
12. The fluid filter according to 9 above, wherein a filter element stopper projection is formed on said cylindrical portion and/or said second joint portion in a site thereof that is contacted by an inner peripheral surface of said filter element.
13. The fluid filter according to 10 above, wherein a relief groove is formed in a boundary site between said pedestal main body and said second joint portion.
14. The fluid filter according to 11 above, wherein a relief groove is formed in a boundary site between said pedestal main body and said second joint portion.
15. The fluid filter according to 12 above, wherein a relief groove is formed in a boundary site between said pedestal main body and said second joint portion.
16. A protector provided in a fluid filter having a filter element, and a cap and a base that house said filter element and can be screwed to each other by relative rotation, comprising:

a support that has a cylindrical portion and a first joint portion provided on one end side of said cylindrical portion, is provided with a plurality of penetrating holes in a peripheral surface of said cylindrical portion, and is inserted into said filter element;

a pedestal having a pedestal main body and a second joint portion provided on said pedestal main body and joined to said first joint portion, a through hole being provided in a partition wall for separating said pedestal main body from said second joint portion;

a valve body provided in a valve body housing portion that is formed by joining said first joint portion to said second joint portion; and

a spring that is provided in said valve body housing portion and biases said valve body to said through hole side,

wherein said support and said pedestal are made of resin, and

said first joint portion and said second joint portion are connected to each other by a snap fit structure.
17. A protector provided in a fluid filter having a filter element, and a cap and a base that house said filter element and can be screwed to each other by relative rotation, comprising:

a support that has a cylindrical portion and a first joint portion provided on one end side of said cylindrical portion, is provided with a plurality of penetrating holes in a peripheral surface of said cylindrical portion, and is inserted into said filter element;

a pedestal having a pedestal main body and a second joint portion provided on said pedestal main body and joined to said first joint portion, a through hole being provided in a partition wall for separating said pedestal main body from said second joint portion;

a valve body provided in a valve body housing portion that is formed by joining said first joint portion to said second joint portion; and

a spring that is provided in said valve body housing portion and biases said valve body to said through hole side,

wherein said support and said pedestal are made of resin,

one of said first joint portion and said second joint portion comprises a pawl portion, and the other comprises an engaging portion that has a cylindrical shape and is engaged with said pawl portion by a snap fit structure,

a tip end surface of said pawl portion is inclined in a circumferential direction of said engaging portion,

said engaging portion comprises one or more engaging ribs provided in an axial direction on an inner peripheral surface thereof, and

an end surface of said engaging rib opposing said tip end surface of said pawl portion is inclined in an identical direction to said tip end surface.

[Effect of the Invention]

According to the protector and the fluid filter using the protector of the present invention, the support and the pedestal are made of resin, and the snap fit structure constituted by the first joint portion and the second joint portion is provided. Therefore, the protector can be assembled easily simply by fitting together the support and the pedestal by a manual operation.

Hence, in contrast to a conventional case in which caulking retention and rivet retention using specialized tools is required, the protector can be assembled easily by a manual operation even in a factory where sufficient tools are not available. Furthermore, the snap fit structure constituted by the joint portions is provided, and therefore the protector can be assembled correctly without the need for strict positioning of the support and the pedestal. Hence, the protector can be assembled easily and accurately by a manual operation.

Moreover, in comparison with a conventional protector that requires rivet retention, the number of components of the protector can be reduced since rivets are not required. Furthermore, protectors having different lengths can be assembled easily simply by attaching supports of differing lengths, and therefore protectors of various lengths can be assembled with a small number of types of components.

Further, when the transverse rib is provided in the interior of the cylindrical portion of the support, the strength of the support can be increased, and the protector and filter element can be prevented from being crushed even when high-pressure fluid flows through the fluid filter.

Further, when the first joint portion includes the pawl portion and the second joint portion includes the engaging portion that engages with the pawl portion, the support and the pedestal can be connected easily and reliably by the engagement between the pawl portion and the engaging portion.

Further, even when an attempt is made to fit together the support and the pedestal by applying excessive force while the pawl portion and the engaging rib are in contact with each other, the support and the pedestal are rotated in the axial direction of the cylindrical portion by the inclined surfaces on the tip end surface of the pawl portion and the end surface of the engaging rib so as to be guided to their correct positions, and therefore damage to the support and the pedestal and so on can be prevented.

Further, when the angular portion of the inner peripheral side end surface of the engaging portion is chamfered and an attempt at assembly is made by applying excessive force while the angular portion of the engaging portion and the pawl portion are in contact with each other, the pawl portion deviates into the engaging portion due to the inclined surfaces on the angular portion of the engaging portion and the tip end surface of the pawl portion such that the support and the pedestal are guided to their correct positions, and therefore damage to the support and the pedestal and so on can be prevented.

Further, when the root side of the pawl portion is provided at an incline so as to approach the central axis of the engaging portion and an attempt at assembly is made by applying excessive force while the spring and the pawl portion are in contact with each other, the spring is guided to its correct position, i.e. on the axis side of the cylindrical portion, by the inclined surface of the root side, and therefore damage to the protector and so on can be prevented.

Further, when the outer peripheral surface angular portion on the pedestal main body side of the orbital rib provided on the cylindrical portion and/or the second joint portion is chamfered, the orbital rib can be prevented from biting into the inner peripheral surface of the filter element during withdrawal of the filter element attached to the protector, and therefore the filter element can be withdrawn easily. Even when the swollen filter element that has absorbed the fluid is withdrawn, the orbital rib can be prevented from biting into the inner peripheral surface of the filter element, and therefore the filter element can be withdrawn easily, enabling an improvement in workability.

Further, when the stopper projection is formed on the cylindrical portion and/or the second joint portion in the site that is contacted by the inner peripheral surface of the filter element, the filter element can be prevented from becoming easily dislodged. In particular, the filter element can be prevented from falling out of the protector even if the fluid filter is assembled by turning the protector, to which the filter element is attached, upside-down, or in other words holding the protector with the pedestal on the upper side.

Further, when the relief groove is formed in the boundary site between the pedestal main body and the second joint portion, water-tightness can be secured without the occurrence of a situation in which a curved surface is formed on the angle of the joint portion during injection molding of the pedestal such that fluid leaks through a gap formed by contact between the end surface of the filter element and the curved surface of the pedestal main body, and therefore the filtering efficiency of the filter can be increased.

### BRIEF DESCRIPTION OF THE DRAWINGS

FIG. 1 is a longitudinal sectional view of a fluid filter according to each embodiment;

FIGS. 2A to 2C are views showing a protector according to a first embodiment, FIG. 2A being an exploded front view, FIG. 2B being a sectional view of FIG. 2A, and FIG. 2C being a post-assembly sectional view;

FIGS. 3A to 3C are views showing a protector according to a second embodiment, FIG. 3A being an exploded front view, FIG. 3B being a sectional view of FIG. 3A, and FIG. 3C being a post-assembly sectional view;

FIG. 4 is a perspective view illustrating an end surface and so on of an engaging rib of a pedestal;

FIG. 5 is a sectional view illustrating the manner in which a support is guided by the end surface of the engaging rib;

FIG. 6 is a sectional view illustrating the manner in which the support is guided by an inner peripheral side end surface angular portion;

FIG. 7 is a sectional view illustrating the manner in which a spring is guided by a root side of a pawl portion;

FIG. 8 is a perspective view showing a separately formed rib attached to the support;

FIGS. 9A and 9B show a protector having a stopper projection on a cylindrical portion thereof, FIG. 9A being an exploded front view, and FIG. 9B being a sectional view of FIG. 9A; and

FIG. 10 is a longitudinal sectional view of a conventional fluid filter.

### DESCRIPTION OF REFERENCE NUMERALS AND SIGNS

1; oil filter (fluid filter), 2; cap, 3; base, 4; casing, 5; element assembly, 6; protector, 7; filter element, 8; support, 9; cylindrical portion, 10; first joint portion, 11; penetrating hole, 12; pedestal, 13; pedestal main body, 14; second joint portion, 15; valve body housing portion, 16; valve body, 17; spring, 18; transverse rib, 19; pawl portion, 20; engaging portion, 21; orbital rib, 22; outer peripheral surface angular portion, 23; stopper projection, 24; relief groove, 25; partition wall, 26; through hole, 27; connecting pawl, 28; case projection portion, 29; drain hole, 30; drainage mechanism, 31; coil spring, 32; holding portion, 33; tip end surface, 34; engaging rib, 35; end surface, 36; inner peripheral side end surface angular portion and 37; root side.

### DETAILED DESCRIPTION OF THE PREFERRED EMBODIMENTS

A protector and a fluid filter using the protector according to the present invention will be described in detail below.

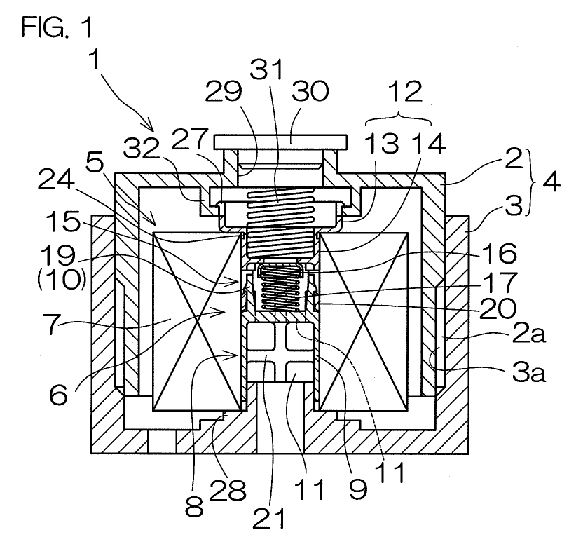

As shown in the example in FIG. 1, a fluid filter 1 includes a filter element 7, a protector 6 for supporting the filter element 7, and a cap 2 and a base 3 that house the filter element 7 and the protector 6 and are capable of forming a casing 4 by being screwed to each other through relative rotation.

Further, the protector 6 includes: a support 8 having a cylindrical portion 9 and a first joint portion 10 provided on one end side of the cylindrical portion 9, a plurality of penetrating holes 11 being provided in a peripheral surface of the cylindrical portion 9; a pedestal 12 having a pedestal main body 13 and a second joint portion 14 that is provided on the pedestal main body 13 and joined to the first joint portion 10; a valve body 16 provided in a valve body housing portion 15 that is formed by joining the first joint portion 10 to the second joint portion 14; and a spring 17 that is provided in the valve body housing portion 15 and biases the valve body 16 toward the pedestal 12 side.

There are no particular limitations on the structure, shape, material and so on of the aforementioned “cap 2” as long as it is engaged to the base 3. A screw mechanism constituted by male and female screw portions that can be screwed to each other may be cited as an example of an attachment mechanism for attaching the cap to the base. A bayonet mechanism constituted by a groove portion and a projecting portion that can be attached to each other or the like may also be used.

The aforementioned “base 3” is typically formed with an inflow passage through which a fluid flows into the casing 4 from the outside and an outflow passage through which the fluid flows out to the outside (not shown).

Examples of the material of the cap 2 and the base 3 include metal and synthetic resin.

The aforementioned “filter element 7” is a member for filtering a fluid as it passes from an outer peripheral side to a central axis portion, and there are no particular limitations on the material and structure thereof. Further, the filter element is a tubular body, but the shape of the outer peripheral side and the inner peripheral side may be similar or different. Moreover, as long as one end surface of the central axis portion is open, the other end surface may be open or closed.

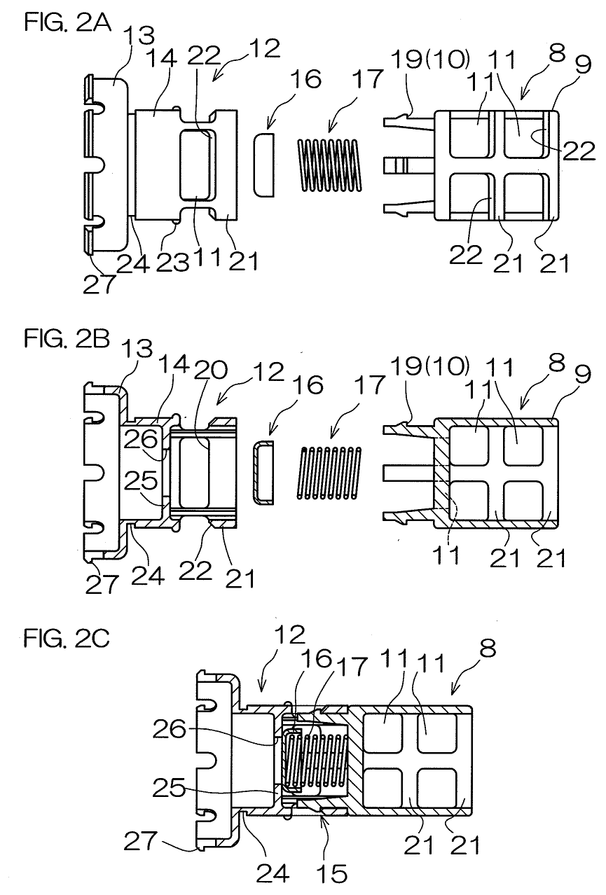

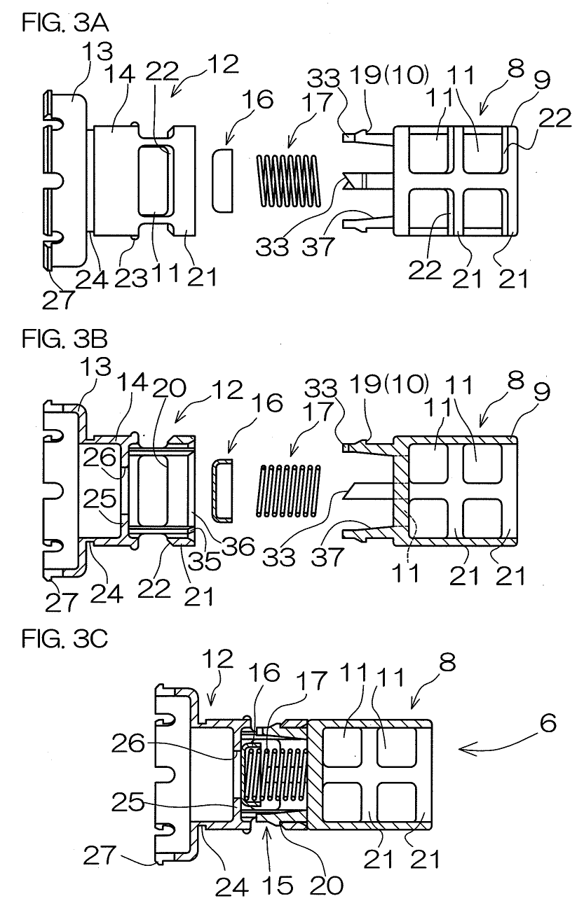

There are no particular limitations on the shape, size and so on of the aforementioned “support 8” as long as it is made of resin and includes the cylindrical portion 9 having the plurality of penetrating holes 11 and the first joint portion that is connected to the pedestal 12 by a snap fit structure. The support 8 may include an orbital rib 21 that extends in a circumferential direction of the cylindrical portion 9, for example. Further, as shown in the example in FIG. 2 or FIG. 3, the orbital rib 21 may be provided by chamfering an outer peripheral surface angular portion 22 on the pedestal main body side.

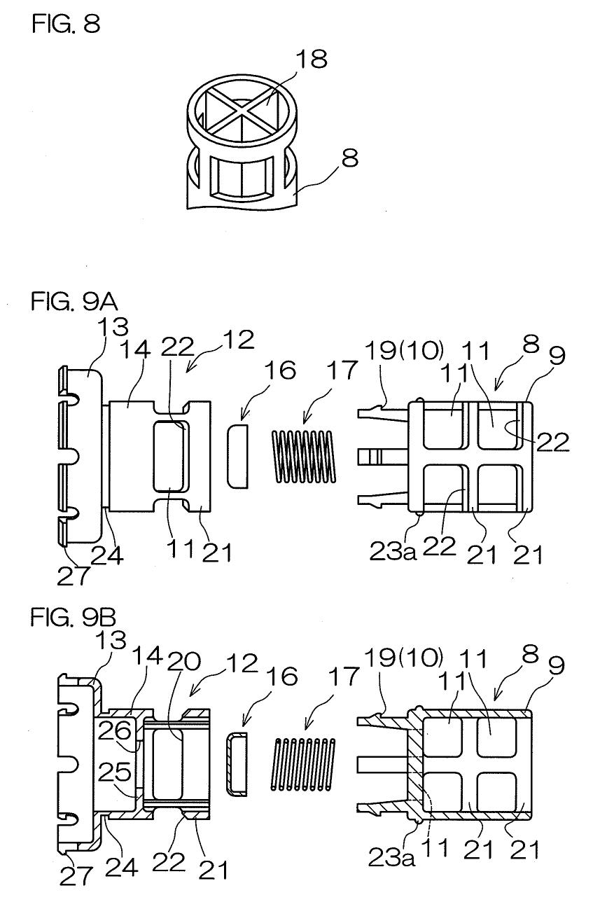

Further, as shown in the example in FIG. 8, the support 8 may include a transverse rib 18 in its interior. There are no particular limitations on the shape, size and so on of the transverse rib 18 as long as it is provided so as to traverse the inside of the cylindrical portion 9 in a diametrical direction such that crushing can be prevented. A pole body having a cross-shaped transverse section, such as that shown in the example in FIG. 8, may be cited as an example of the shape of the transverse rib 18.

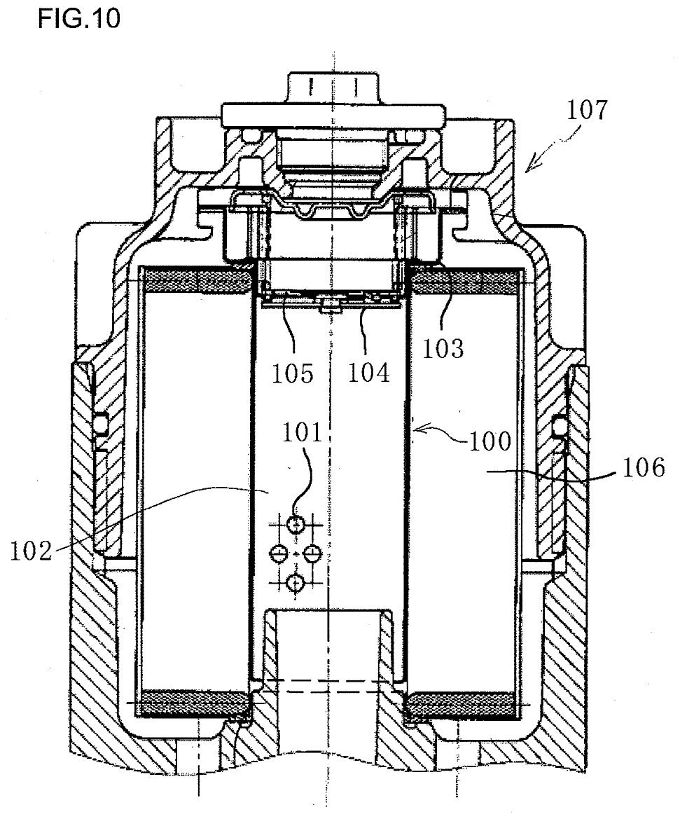

Further, as shown in the example in FIG. 9, a stopper projection 23a may be provided in a site of the cylindrical portion 9 of the support 8 that is contacted by an inner peripheral surface of the filter element 7.

Note that the support may be formed integrally, or a single support may be formed by connecting a plurality of supports in an axial direction of the cylindrical portion 9.

There are no particular limitations on the shape, size and so on of the aforementioned “pedestal 12” as long as it is made of resin, includes the pedestal main body 13, which has a larger diameter than the support 8 so as to contact the filter element 7, and includes the second joint portion 14 that is connected to the support 8 by a snap fit structure. An orbital rib 21 may be provided in the circumferential direction of the pedestal 12 in the site that is contacted by the inner peripheral surface of the filter element 7, for example. Further, as shown in the example in FIG. 2 or FIG. 3, the orbital rib 21 may be provided by chamfering an outer peripheral surface angular portion 22 on the pedestal main body side. A stopper projection 23 may be provided in a site of the second joint portion 14 of the pedestal 12 that is contacted by the inner peripheral surface of the filter element 7. There are no particular limitations on the shape, size, number and so on of the stopper projection 23 as long as it prevents the filter element 7 from falling. A relief groove 24 may also be formed in the pedestal 12 in a boundary site between the pedestal main body 13 and the second joint portion 14, i.e. a contact position of an edge portion of the inner peripheral surface of the filter element 7.

The snap fit structure constituted by the first joint portion 10 and the second joint portion 14 may be formed arbitrarily. As shown in FIG. 2 or FIG. 3, for example, the snap fit structure may be constituted by a pawl portion 19 formed on an edge portion of the cylindrical portion 9, and an engaging portion 20 formed from the orbital rib 21 that serves as an edge portion of a through hole 11 formed in a cylindrical body that extends from the pedestal main body 13. With this snap fit structure, the pawl portion 19 may be connected to the engaging portion 20 in a snap-fitted manner.

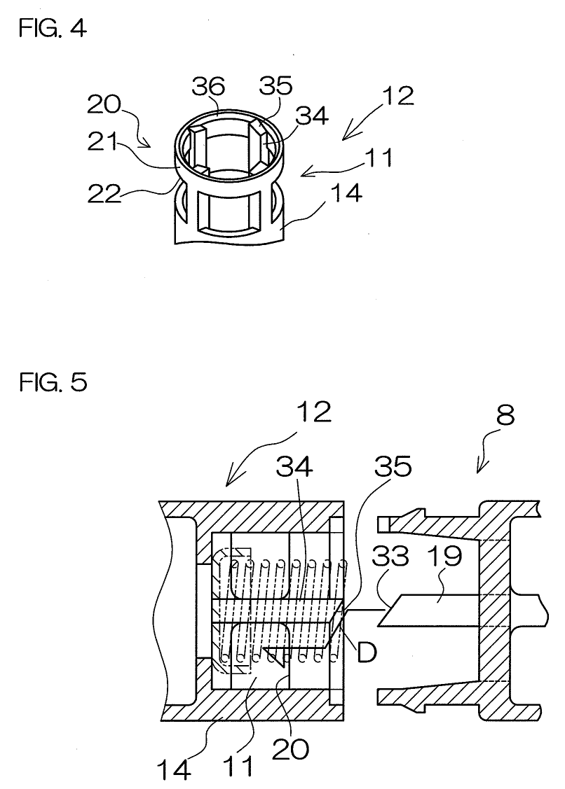

Further, as shown in the example in FIG. 4, the cylindrical body formed with the engaging portion 20 may be provided with one or more engaging ribs 34 provided axially on an inner peripheral surface of the cylindrical body. Further, as shown in FIGS. 3 to 5, the pawl portion 19 and the engaging rib 34 may be formed such that a tip end surface 33 of the pawl portion 19 and an end surface 35 of the engaging rib 34, which oppose each other when the protector is assembled, are inclined in a circumferential direction of the cylindrical body formed with the engaging portion 20. By providing these inclined surfaces, as shown in FIG. 5, when the tip end surface 33 and the end surface 35 are pressed together during assembly, the support 8 and/or the pedestal 12 are rotated in the axial direction of the cylinder by the pressing force until the tip end surface 33 and the end surface 35 no longer contact each other, whereupon the pawl portion 19 is inserted into the engaging portion 20 until the pawl portion 19 and the engaging portion 20 are engaged.

Thus, the support and the pedestal are guided to their correct positions such that damage and the like to the support, the pedestal, and so on can be prevented.

Further, the inclined surfaces may face the clockwise or counterclockwise direction, and the support 8 and pedestal 12 may be rotated in an identical direction regardless of the contact between the tip end surfaces 33 and the end surfaces 35 thereof. The angle of incline may also be selected arbitrarily, for example between 20° and 70°. Further, the tip end surface and the end surface 35 are preferably substantially parallel, but are not limited thereto, and need not be parallel.

Note that the present invention is not limited to a case in which the pawl portion is formed on the first joint portion and the engaging portion is formed on the second joint portion 14, as shown in FIG. 3, and instead, the first joint portion 10 may include an engaging portion that is constituted by an orbital rib serving as an edge portion of a through hole 11 provided in a cylindrical body that extends to an edge portion of the cylindrical portion 9, while the second joint portion 14 has a pawl portion extending from the pedestal main body 13.

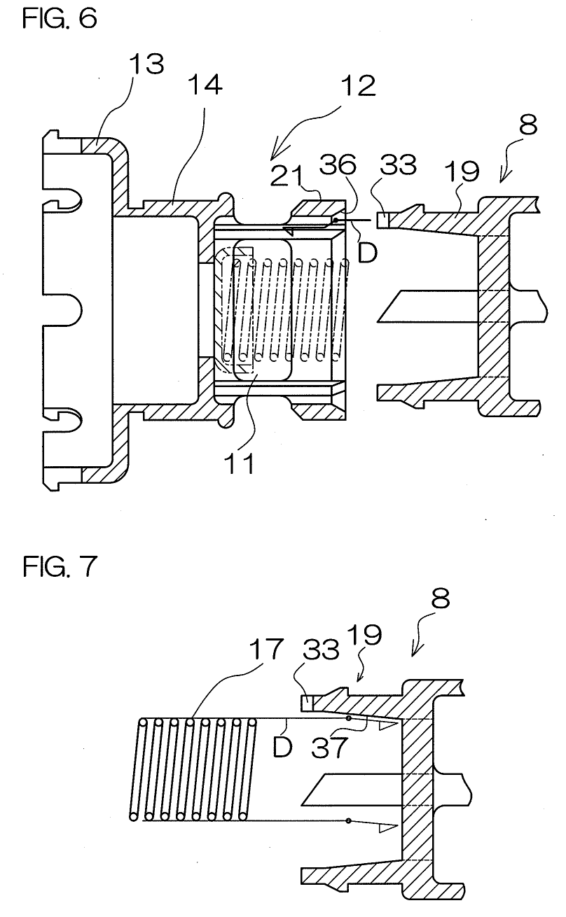

As shown in the examples in FIG. 3 and FIG. 6, the engaging portion 20 may be formed by chamfering an angular portion 36 of an inner peripheral side end surface. As shown in the example in FIG. 6, when the pawl portion 19 comes into contact with such a chamfered surface during assembly, the pawl portion 19 is moved in an inside direction of the engaging portion 20 by the pressing force that is applied to the pawl portion 19, and as a result, the pawl portion 19 can be inserted into the inner periphery of the cylindrical body and engaged with the engaging portion 20.

Thus, the support and the pedestal are guided to their correct positions such that damage and the like to the support, the pedestal, and so on can be prevented.

Further, as shown in the examples in FIG. 3 and FIG. 7, the pawl portion 19 may be provided at an incline such that a root side 37 thereof approaches a central axis of the engaging portion. By providing this incline, the spring 17 is moved toward the central axis of the engaging portion 20 by the pressing force that is applied to the spring 17 when the spring 17 contacts the pawl portion 19 during assembly, as shown in the example in FIG. 7, and therefore the spring 17 is housed in the valve body housing portion positioned in the central axis.

Thus, the spring is guided to its correct position, and therefore assembly errors caused when the spring bursts out due to the application of excessive force, damage to the support and pedestal, and so on can be prevented.

Note that as long as at least the surface of the root side 37 on the central axis side of the engaging portion 20 is inclined, the outer peripheral side thereof need not be inclined, as shown in the example in FIG. 7.

There are no particular limitations on the shape and material of the aforementioned “valve body 16” as long as it is capable of blocking a through hole 26 provided in a partition wall 25 formed in the pedestal main body 13 and/or the second joint portion 14. There are no particular limitations on the shape and material of the aforementioned “spring 17” as long as it is capable of biasing the valve body 16 so as to block the through hole 26. A metallic coil spring may be cited as an example of the spring 17.

### Embodiments

Specific embodiments of the present invention will be described below using the drawings. Note that in each embodiment, an oil filter that is attached to a cylinder block (not shown) of an internal combustion engine so as to filter oil for lubricating the interior of the cylinder block is employed as an example of the “fluid filter” according to the present invention.

### 1. First Embodiment

### (1) Constitution of Oil Filter

As shown in FIG. 1, an oil filter 1 according to a first embodiment includes a casing 4 constituted by a closed-end cylindrical cap 2 and a base 3 that are made of metal and can be screwed together through relative rotation.

A male screw portion 2a is formed on an outer peripheral surface of the cap 2, and an O-ring (not shown) is attached thereto. Further, a female screw portion 3a is formed on an inner peripheral surface of the base 3. When the male screw portion 2a and the female screw portion 3a are screwed together, the interior of the casing 4 is sealed by the O-ring and thereby maintained in a liquid-tight condition.

An element assembly 5 is housed in the interior of the casing 4. The element assembly 5 is formed by attaching a cylindrical filter element 7 to an outer periphery of a substantially cylindrical protector 6, and is sandwiched between the cap 2 and the base 3.

The filter element 7 is formed by folding filter paper into a fluted chrysanthemum shape. The filter element 7 contacts a contact surface of a pedestal 12 of the protector 6 and a case projection portion 28 provided on the base 3, and is held in a liquid-tight condition via a sealing member (not shown).

As shown in FIGS. 1 and 2, the protector 6 is constituted by a support 8, the pedestal 12, a valve body 16, and a spring 17. The support 8 and pedestal 12 are made of an identical resin.

The support 8 includes a cylindrical portion 9 having a plurality of penetrating holes 11 in a peripheral surface and a bottom surface thereof, and a first joint portion 10 provided on one end side of the cylindrical portion 9. The joint portion 10 also has a pawl portion 19 for joining the support 8 to the pedestal 12.

The pedestal 12 includes a pedestal main body 13 having a larger diameter than the cylindrical portion 9, and a cylindrical second joint portion 14 having an identical diameter to the cylindrical portion 9. The second joint portion 14 is also provided with a plurality of penetrating holes 11 in a peripheral surface thereof, a partition wall 25 provided in the cylinder, and a through hole 26 formed in the center of the partition wall 25. An orbital rib 21 forming an edge portion of the penetrating holes 11 engages with the pawl portion 19 to form an engaging portion 20 having a snap fit structure.

Further, a valve body housing portion 15 is formed by the peripheral surface of the second joint portion 14, the partition wall 25 separating the pedestal main body 13 and the second joint portion 14, and a first joint portion 10 side bottom surface (end surface) of the cylindrical portion 9 joined by the first joint portion 10.

The valve body 16 is used to block the through hole 26 provided in the partition wall 25, and is shaped such that wall portions stand upright from the periphery of a disk. Further, the valve body 16 is provided in the valve body housing portion 15. The spring 17 is a coil spring that presses the valve body against the through hole 26 during normal periods and separates the valve body 16 from the through hole 26 when the pressure of oil on the outer peripheral side of the filter element 7 in the casing 4 is high such that the oil is discharged to the outside through a gap generated as a result.

Further, the periphery of the penetrating hole 11 in the support 8 forms a rib. In particular, an orbital rib 21 extending in the circumferential direction is formed by chamfering an outer peripheral surface angular portion 22 of the orbital rib 21 on the pedestal main body 13 side, as shown in FIG. 2A.

The second joint portion 14 of the pedestal 12 is cylindrical, and similarly to the support 8 includes a plurality of penetrating holes 11. Also similarly to the support 8, the periphery of the penetrating hole 11 forms a rib. Also similarly to the support 8, an outer peripheral surface angular portion 22 of an orbital rib 21 on the pedestal 12 side is chamfered, as shown in FIG. 2B. This orbital rib 21 doubles as the engaging portion 20.

Further, a stopper projection 23 is formed on the outer peripheral surface of the second joint portion 14. The stopper projection 23 is a minute projection, and is formed in two locations in opposing positions in the circumferential direction.

Further, a relief groove 24 is formed in a boundary site between the pedestal main body 13 and the second joint portion 14 of the pedestal 12. The relief groove 24 is a recess formed at the base of the second joint portion 14 and oriented in a central direction. Further, a connecting pawl 27 for connecting the pedestal main body 13 to the cap 2 is formed on the pedestal main body 13.

Meanwhile, a drain hole 29 formed with a female screw on its inner periphery is provided in the center of a bottom portion of the cap 2. Further, an O-ring (not shown) is attached to the bottom portion of the cap 2 so as to surround the drain hole 29. A drainage mechanism 30 is provided in the drain hole 29. A well-known or novel drainage mechanism may be employed as the drainage mechanism 30 as appropriate.

### (2) Actions of Oil Filter

Actions of the oil filter 1 having the above constitution will now be described.

The protector 6 of the element assembly 5 is assembled before assembling the oil filter 1. At this time, as shown in FIG. 2C, the valve body 16 and the spring 17 are inserted into the second joint portion 14 of the pedestal 12, whereupon the support 8 is joined to the pedestal 12. Here, assembly can be achieved easily using a snap fit structure simply by engaging the pawl portion 19 of the support 8 with the engaging portion 20 of the pedestal 12.

The filter element 7 is then attached to the support 8 and the second joint portion 14 of the pedestal 12 in the assembled protector 6. Thus, the element assembly 5 is completed. A coil spring 31 is housed in the pedestal main body 13 of the protector 6 of the element assembly 5, and the connecting pawl 27 is engaged with a holding portion 32 of the cap 2. The cap 2 is then screwed to the base 3, whereby the oil filter 1 is assembled.

### (3) Effects of First Embodiment

According to the oil filter 1 of the first embodiment, the support 8 and pedestal 12 include the first joint portion 10 and the second joint portion 14 forming the snap fit structure, and therefore the protector 6 can be assembled easily by a one-touch manual operation. Therefore, in contrast to a conventional case in which rivet retention using a specialized tool is required, the protector 6 can be assembled easily by a manual operation even in overseas locations where sufficient tools are not available. Furthermore, in comparison with a conventional protector that requires rivet retention, the number of components can be reduced since rivets are not required. Moreover, in contrast to a conventional protector, tools are not required during assembly, and therefore protectors 6 having different lengths can be assembled easily simply by attaching supports 8 of differing lengths.

Further, the snap fit structure constituted by the pawl portion 19 of the support 8 and the engaging portion 20 of the pedestal 12 is provided, and therefore the support 8 and the pedestal 12 can be connected easily and reliably by engaging the pawl portion 19 and the engaging portion 20. Moreover, the outer peripheral surface angular portions 22 of the orbital ribs 21 on the support 8 and the pedestal 12 are chamfered, and therefore, when the filter element 7 attached to the protector 6 is withdrawn, the orbital ribs 21 can be prevented from biting into the inner peripheral surface of the filter element 7. As a result, the filter element 7 can be withdrawn easily.

Further, the stopper projection 23 is formed on a part of the outer peripheral surface of the pedestal 12, and therefore the filter element 7 can be prevented from becoming easily dislodged. Hence, when assembling the fluid filter, the filter element 7 can be prevented from falling out of the protector 6 even if the protector 6, to which the filter element 7 is attached, is turned upside-down, for example, or in other words even if the protector 6 is held with the pedestal 12 on the upper side.

Moreover, the relief groove 24 is formed in the boundary site between the pedestal main body 13 and the second joint portion 14 of the pedestal 12, and therefore it is possible to prevent minute arcs from forming in the connection portion between the second joint portion 14 and the pedestal main body 13 when forming the pedestal 12 through injection molding. Accordingly, liquid-tightness can be secured between the end surface of the filter element 7 and the pedestal main body 13, and as a result, the filtering efficiency of the filter can be improved.

### 2. Second Embodiment

### (1) Constitution of Oil Filter

As shown in FIG. 1, an oil filter 1 according to a first embodiment includes a casing 4 constituted by a closed-end cylindrical cap 2 and a base 3 that are made of metal and can be screwed together through relative rotation.

A male screw portion 2a is formed on an outer peripheral surface of the cap 2, and an O-ring (not shown) is attached thereto. Further, a female screw portion 3a is formed on an inner peripheral surface of the base 3. When the male screw portion 2a and the female screw portion 3a are screwed together, the interior of the casing 4 is sealed by the O-ring and thereby maintained in a liquid-tight condition.

An element assembly 5 is housed in the interior of the casing 4. The element assembly 5 is formed by attaching a cylindrical filter element 7 to an outer periphery of a substantially cylindrical protector 6, and is sandwiched between the cap 2 and the base 3.

The filter element 7 is formed by folding filter paper into a fluted chrysanthemum shape. The filter element 7 contacts a contact surface of a pedestal 12 of the protector 6 and a case projection portion 28 provided on the base 3, and is held in a liquid-tight condition via a sealing member (not shown).

As shown in FIGS. 1 and 3, the protector 6 is constituted by a support 8, the pedestal 12, a valve body 16, and a spring 17. The support 8 and pedestal 12 are made of an identical resin.

The support 8 includes a cylindrical portion 9 having a plurality of penetrating holes 11 in a peripheral surface and a bottom surface thereof, and a first joint portion 10 provided on one end side of the cylindrical portion 9. The joint portion 10 also has a pawl portion 19 for joining the support 8 to the pedestal 12.

Further, the pawl portion 19 includes a root side 37 extending from one end side of the cylindrical portion 9 and a pawl portion main body formed on the tip end side of the root side 37. Furthermore, a tip end surface 33 serving as the tip end of the pawl portion 19 is provided at an incline around the circumference of the cylindrical portion 9.

The pedestal 12 includes a pedestal main body 13 having a larger diameter than the cylindrical portion 9, and a cylindrical second joint portion 14 having an identical diameter to the cylindrical portion 9. The second joint portion 14 is also provided with a plurality of penetrating holes 11 in a peripheral surface thereof, a partition wall 25 provided in the cylinder, and a through hole 26 formed in the center of the partition wall 25. An orbital rib 21 forming an edge portion of the penetrating holes 11 engages with the pawl portion 19 to form an engaging portion 20 having a snap fit structure. Further, an engaging rib 34 is provided between adjacent penetrating holes 11 in the circumferential direction. The engaging rib 34 projects from the inner circumference of the second joint portion 14. Further, an end surface 35 of the engaging rib 34 opposing the cylindrical portion 9, and is provided at an incline having an identical orientation and a substantially parallel angle to the tip end surface 33. Furthermore, an inner peripheral side end surface angular portion 36 of the orbital rib 21 is chamfered so as to form an inclined surface.

Further, a valve body housing portion 15 is formed by the peripheral surface of the second joint portion 14, the partition wall 25 separating the pedestal main body 13 and the second joint portion 14, and a first joint portion 10 side bottom surface (end surface) of the cylindrical portion 9 joined by the first joint portion 10.

The valve body 16 is used to block the through hole 26 provided in the partition wall 25, and is shaped such that wall portions stand upright from the periphery of a disk. Further, the valve body 16 is provided in the valve body housing portion 15. The spring 17 is a coil spring that presses the valve body 16 against the through hole 26 during normal periods and separates the valve body 16 from the through hole 26 when the pressure of oil on the outer peripheral side of the filter element 7 in the casing 4 is high such that the oil is discharged to the outside through a gap generated as a result.

Further, the periphery of the penetrating hole 11 in the support 8 forms a rib. In particular, an orbital rib 21 extending in the circumferential direction is formed by chamfering an outer peripheral surface angular portion 22 of the orbital rib 21 on the pedestal main body 13 side, as shown in FIG. 3A.

The second joint portion 14 of the pedestal 12 is cylindrical, and similarly to the support 8 includes a plurality of penetrating holes 11. Also similarly to the support 8, the periphery of the penetrating hole 11 forms a rib. The first joint portion 10 side end surface includes an inclined surface. Also similarly to the support 8, an outer peripheral surface angular portion 22 of an orbital rib 21 on the pedestal 12 side is chamfered, as shown in FIG. 3B. This orbital rib 21 doubles as the engaging portion 20.

Further, a stopper projection 23 is formed on the outer peripheral surface of the second joint portion 14. The stopper projection 23 is a minute projection, and is formed in two locations in opposing positions in the circumferential direction.

Further, a relief groove 24 is formed in a boundary site between the pedestal main body 13 and the second joint portion 14 of the pedestal 12. The relief groove 24 is a recess formed at the base of the second joint portion 14 and oriented in a central direction. Further, a connecting pawl 27 for connecting the pedestal main body 13 to the cap 2 is formed on the pedestal main body 13.

Meanwhile, a drain hole 29 formed with a female screw on its inner periphery is provided in the center of a bottom portion of the cap 2. Further, an O-ring (not shown) is attached to the bottom portion of the cap 2 so as to surround the drain hole 29. A drainage mechanism 30 is provided in the drain hole 29. A well-known or novel drainage mechanism may be employed as the drainage mechanism 30 as appropriate.

### (2) Actions of Oil Filter

Actions of the oil filter 1 having the above constitution will now be described.

The protector 6 of the element assembly 5 is assembled before assembling the oil filter 1. At this time, as shown in FIG. 3C, the valve body 16 and the spring 17 are inserted into the second joint portion 14 of the pedestal 12, whereupon the support 8 is joined to the pedestal 12. Here, assembly can be achieved easily using a snap fit structure simply by engaging the pawl portion 19 of the support 8 with the engaging portion 20 of the pedestal 12.

The filter element 7 is then attached to the support 8 and the second joint portion 14 of the pedestal 12 in the assembled protector 6. Thus, the element assembly 5 is completed. A coil spring 31 is housed in the pedestal main body 13 of the protector 6 of the element assembly 5, and the connecting pawl 27 is engaged with a holding portion 32 of the cap 2. The cap 2 is then screwed to the base 3, whereby the oil filter 1 is assembled.

### (3) Effects of Second Embodiment

According to the oil filter 1 of the second embodiment, the support 8 and pedestal 12 include the first joint portion 10 and the second joint portion 14 forming the snap fit structure, and therefore the protector 6 can be assembled easily by a one-touch manual operation. Therefore, in contrast to a conventional case in which rivet retention using a specialized tool is required, the protector 6 can be assembled easily by a manual operation even in overseas locations where sufficient tools are not available. Furthermore, in comparison with a conventional protector that requires rivet retention, the number of components can be reduced since rivets are not required. Moreover, in contrast to a conventional protector, tools are not required during assembly, and therefore protectors 6 having different lengths can be assembled easily simply by attaching supports 8 of differing lengths. Further, the chamfered surfaces of the tip end surface 33 of the pawl portion 19, the end surface 35 of the engaging rib 34, and the inner peripheral side end surface angular portion 36 of the orbital rib 21 are inclined surfaces, and therefore the support 8 and the pedestal 12 are guided to their correct positions when the protector 6 is assembled, thereby preventing damage and the like to the support 8, the pedestal 12, and so on.

Moreover, the root side 37 of the pawl portion 19 is provided at an incline, and therefore the spring 17 is housed correctly in the valve body housing portion 15. As a result, assembly errors caused when the spring 17 bursts out due to the application of excessive force, damage to the support 8 and the pedestal 12, and so on can be prevented.

Further, the snap fit structure constituted by the pawl portion 19 of the support 8 and the engaging portion 20 of the pedestal 12 is provided, and therefore the support 8 and the pedestal 12 can be connected easily and reliably by engaging the pawl portion 19 and the engaging portion 20. Moreover, the outer peripheral surface angular portions 22 of the orbital ribs 21 on the support 8 and the pedestal 12 are chamfered, and therefore, when the filter element 7 attached to the protector 6 is withdrawn, the orbital ribs 21 can be prevented from biting into the inner peripheral surface of the filter element 7. As a result, the filter element 7 can be withdrawn easily.

Further, the stopper projection 23 is formed on a part of the outer peripheral surface of the pedestal 12, and therefore the filter element 7 can be prevented from becoming easily dislodged. Hence, when assembling the fluid filter, the filter element 7 can be prevented from falling out of the protector 6 even if the protector 6, to which the filter element 7 is attached, is turned upside-down, for example, or in other words even if the protector 6 is held with the pedestal 12 on the upper side.

Moreover, the relief groove 24 is formed in the boundary site between the pedestal main body 13 and the second joint portion 14 of the pedestal 12, and therefore it is possible to prevent minute arcs from forming in the connection portion between the second joint portion 14 and the pedestal main body 13 when forming the pedestal 12 through injection molding. Accordingly, liquid-tightness can be secured between the end surface of the filter element 7 and the pedestal main body 13, and as a result, the filtering efficiency of the filter can be improved.

Note that the present invention is not limited to the embodiments described above, and may be implemented after being subjected to various modifications within the scope thereof according to the object and application thereof. More specifically, in the embodiments described above, the snap fit structure is constituted by the pawl portion 19 of the support 8 and the engaging portion 20 of the pedestal 12, but the present invention is not limited thereto, and the snap fit structure may be constituted by a pawl portion 19 on the pedestal 12 and an engaging portion 20 on the support 8, for example. Alternatively, the snap fit structure may be constituted by a combination other than the pawl portion 19 and the engaging portion 20.

Further, in the embodiments described above, the pedestal main body 13 side edge of the orbital ribs 21 on the support 8 and the pedestal 12 is chamfered, but the present invention is not limited thereto, and chamfering need not be performed when the filter element 7 can be withdrawn non-problematically, for example.

Furthermore, in the embodiments described above, the stopper projection 23 is formed on a part of the outer peripheral surface of the second joint portion 14 of the pedestal 12, but the present invention is not limited thereto, and a stopper projection 23a may be formed on a part of the outer peripheral surface of the support 8, as shown in FIG. 9, for example. Alternatively, the stopper projection 23 need not be provided when the filter element 7 is not likely to fall.

Also in the embodiments described above, the relief groove 24 of the pedestal 12 is a recess formed at the base of the second joint portion 14 and oriented in the central direction, but the present invention is not limited thereto, and the relief groove 24 may be a recess formed at the base of the second joint portion 14 and oriented in a lengthwise direction, for example. Alternatively, the relief groove 24 may be omitted.

Also in the embodiments described above, the support 8 has a hollow cylindrical structure, but the present invention is not limited thereto, and a separate transverse rib 18 may be provided in the interior of the support 8, for example. As shown in FIG. 8, the transverse rib 18 may have a cross-shaped cross-section or the like. In this case, the strength of the support 8 can be increased. At this time, the valve body housing portion 15 (not shown) is formed by the peripheral surface of the second joint portion 14, the partition wall 25 separating the pedestal main body 13 from the second joint portion 14, and a first joint portion 10 side end surface of the transverse rib 18 joined by the first joint portion 10.

Also in the embodiments described above, the pedestal 12 includes the second joint portion 14 having the same diameter as the support 8, but the present invention is not limited thereto, and the second joint portion 14 may be omitted, for example.

The protector and the fluid filter using the protector are employed as a technique for facilitating the assembly of a protector used in a fluid filter, and may be employed particularly favorably as a technique for facilitating the assembly of a protector for an oil filter that filters oil used in an internal combustion engine.

What is claimed is:

1. A fluid filter, comprising:
a filter element;
a protector for supporting said filter element; and
a cap and a base that house said filter element and said protector and can be screwed to each other by relative rotation,
wherein said protector comprises:
a support having a cylindrical portion and a first joint portion provided on one end side of said cylindrical portion, a plurality of penetrating holes being provided in a peripheral surface of said cylindrical portion;
a pedestal having a pedestal main body and a second joint portion provided on said pedestal main body and joined to said first joint portion, a through hole being provided in a partition wall for separating said pedestal main body from said second joint portion;
a valve body provided in a valve body housing portion that is formed by joining said first joint portion to said second joint portion; and
a spring that is provided in said valve body housing portion and biases said valve body to said through hole side,
said support and said pedestal are made of resin, and
said first joint portion and said second joint portion are connected to each other by a snap fit structure.

2. The fluid filter according to claim 1, wherein said cylindrical portion further comprises a transverse rib that traverses the interior thereof in a diametrical direction.

3. The fluid filter according to claim 2, wherein said first joint portion comprises a pawl portion, and said second joint portion comprises an engaging portion that engages with said pawl portion.

4. The fluid filter according to claim 1, wherein one of said first joint portion and said second joint portion comprises a pawl portion, and the other has a cylindrical shape and comprises an engaging portion that is engaged with said pawl portion by a snap fit structure,
a tip end surface of said pawl portion is inclined in a circumferential direction of said engaging portion,
said engaging portion comprises one or more engaging ribs provided in an axial direction on an inner peripheral surface thereof, and
an end surface of said engaging rib opposing said tip end surface of said pawl portion is inclined in an identical direction to said tip end surface.

5. The fluid filter according to claim 4, wherein an angular portion on an inner peripheral side end surface of said engaging portion is chamfered.

6. The fluid filter according to claim 5, wherein said pawl portion is provided at an incline such that a root side thereof approaches a central axis of said engaging portion.

7. The fluid filter according to claim 2, wherein said cylindrical portion and/or said second joint portion comprises an orbital rib provided in a circumferential direction, and an outer peripheral surface angular portion of said orbital rib on said pedestal main body side is chamfered.

8. The fluid filter according to claim 3, wherein said cylindrical portion and/or said second joint portion comprises an orbital rib provided in a circumferential direction, and an outer peripheral surface angular portion of said orbital rib on said pedestal main body side is chamfered.

9. The fluid filter according to claim 6, wherein said cylindrical portion and/or said second joint portion comprises an orbital rib provided in a circumferential direction, and an outer peripheral surface angular portion of said orbital rib on said pedestal main body side is chamfered.

10. The fluid filter according to claim 7, wherein a filter element stopper projection is formed on said cylindrical portion and/or said second joint portion in a site thereof that is contacted by an inner peripheral surface of said filter element.

11. The fluid filter according to claim 8, wherein a filter element stopper projection is formed on said cylindrical portion and/or said second joint portion in a site thereof that is contacted by an inner peripheral surface of said filter element.

12. The fluid filter according to claim 9, wherein a filter element stopper projection is formed on said cylindrical portion and/or said second joint portion in a site thereof that is contacted by an inner peripheral surface of said filter element.

13. The fluid filter according to claim 10, wherein a relief groove is formed in a boundary site between said pedestal main body and said second joint portion.

14. The fluid filter according to claim 11, wherein a relief groove is formed in a boundary site between said pedestal main body and said second joint portion.

15. The fluid filter according to claim 12, wherein a relief groove is formed in a boundary site between said pedestal main body and said second joint portion.

16. A protector provided in a fluid filter having a filter element, and a cap and a base that house said filter element and can be screwed to each other by relative rotation, comprising:
a support that has a cylindrical portion and a first joint portion provided on one end side of said cylindrical portion, is provided with a plurality of penetrating holes in a peripheral surface of said cylindrical portion, and is inserted into said filter element;
a pedestal having a pedestal main body and a second joint portion provided on said pedestal main body and joined to said first joint portion, a through hole being provided in a partition wall for separating said pedestal main body from said second joint portion;
a valve body provided in a valve body housing portion that is formed by joining said first joint portion to said second joint portion; and
a spring that is provided in said valve body housing portion and biases said valve body to said through hole side,
wherein said support and said pedestal are made of resin, and
said first joint portion and said second joint portion are connected to each other by a snap fit structure.

17. A protector provided in a fluid filter having a filter element, and a cap and a base that house said filter element and can be screwed to each other by relative rotation, comprising:
a support that has a cylindrical portion and a first joint portion provided on one end side of said cylindrical portion, is provided with a plurality of penetrating holes in a peripheral surface of said cylindrical portion, and is inserted into said filter element;
a pedestal having a pedestal main body and a second joint portion provided on said pedestal main body and joined to said first joint portion, a through hole being provided in a partition wall for separating said pedestal main body from said second joint portion;
a valve body provided in a valve body housing portion that is formed by joining said first joint portion to said second joint portion; and
a spring that is provided in said valve body housing portion and biases said valve body to said through hole side,
wherein said support and said pedestal are made of resin,
one of said first joint portion and said second joint portion comprises a pawl portion, and the other comprises an engaging portion that has a cylindrical shape and is engaged with said pawl portion by a snap fit structure,
a tip end surface of said pawl portion is inclined in a circumferential direction of said engaging portion,
said engaging portion comprises one or more engaging ribs provided in an axial direction on an inner peripheral surface thereof, and
an end surface of said engaging rib opposing said tip end surface of said pawl portion is inclined in an identical direction to said tip end surface.
